(19) United States
(12) Patent Application Publication
(10) Pub. No.: US 2011/0271783 A1
(43) Pub. Date: Nov. 10, 2011

(54) CONSTANT SPEED DEVICE FOR A MOTORCYCLE

(76) Inventor: YU-LUNG HSIA, Tainan (TW)

(21) Appl. No.: 12/773,836

(22) Filed: May 4, 2010

(51) Int. Cl. B62K 23/04; G05G 5/06

(52) U.S. Cl. 74/488

(57) ABSTRACT

A constant speed device for a motorcycle having a twist grip throttle and has a clamping segment and a pressing segment. The clamping segment a clamping space, an abutting face and a gap. The clamping space is defined through the clamping segment to mount around the twist grip throttle of the motorcycle. The abutting face is formed around the clamping space of the clamping segment to abut with the twist grip throttle. The gap is formed through a side of the clamping segment and communicates with the clamping space to allow the twist grip throttle mounting in the clamping space of the clamping segment. The pressing segment is connected to the clamping segment opposite to the gap.

### BACKGROUND OF THE INVENTION

1. Field of the Invention

The present invention relates to a constant speed device, and more particularly to a constant speed device for providing a constant speed effect to a motorcycle.

2. Description of the Prior Arts

When riding a motorcycle, one of the rider's hands needs to grip and rotate a twist grip throttle of the motorcycle to move the motorcycle forward. When the hand removes from the twist grip throttle of the motorcycle, the moving speed of the motorcycle is decelerated. Therefore, the moving speed of the motorcycle is related to and controlled by the rotating angle of the twist grip throttle of the motorcycle. In a long-distance, the rider needs to grip and rotate the twist grip throttle of the motorcycle continually to keep the motorcycle moving forward. The long period of time of griping and rotating the twist grip throttle of the motorcycle will cause the rider feeling tired and may get hurt or die in a traffic accident. In addition, when the rider wants to keep the motorcycle moving at a constant speed in a long-distance, the rider needs to control the rotating angle of the twist grip throttle of the motorcycle by hands and this will cause the motorcycle to move at an indefinite speed. Therefore, the conventional motorcycle does not have a constant speed function.

In order to provide a constant speed effect to the motorcycle to allow the rider not to grip and rotate the twist grip throttle to control the moving speed of the motorcycle by hands, an electronic constant speed device can be mounted on the motorcycle. However, the cost of assembling the conventional electronic constant speed on the motorcycle is expensive and inconvenient.

To overcome the shortcomings, the present invention provides a constant speed device for motorcycle to mitigate or obviate the aforementioned problems.

### SUMMARY OF THE INVENTION

The main objective of the present invention is to provide a constant speed device and more particularly to a constant speed device that can provide a constant speed effect to a motorcycle.

The constant speed device for a motorcycle having a twist grip throttle in accordance with the present invention has a clamping segment and a pressing segment. The clamping segment a clamping space, an abutting face and a gap. The clamping space is defined through the clamping segment to mount around the twist grip throttle of the motorcycle. The abutting face is formed around the clamping space of the clamping segment to abut with the twist grip throttle. The gap is formed through a side of the clamping segment and communicates with the clamping space to allow the twist grip throttle mounting in the clamping space of the clamping segment. The pressing segment is connected to the clamping segment opposite to the gap.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a constant speed device in accordance with the present invention;

FIG. 2 is an operational perspective view of the constant speed device in FIG. 1 mounted on a twist grip throttle of a motorcycle; and

FIGS. 3A to 3C are operational side views of the constant speed device in FIG. 2 mounted on the twist grip throttle of the motorcycle.

### DETAILED DESCRIPTION OF THE PREFERRED EMBODIMENTS

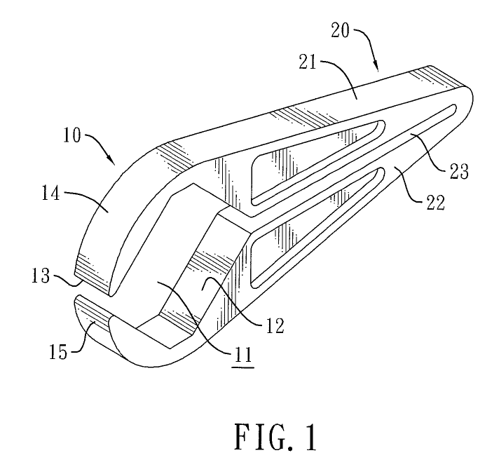

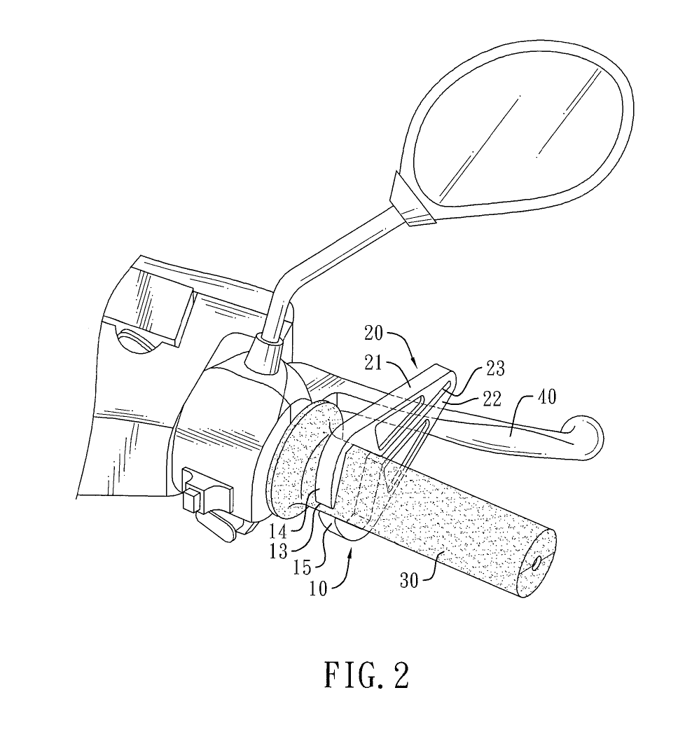

With reference to FIGS. 1 and 2, a constant speed device for a motorcycle having a twist grip throttle (30) and a brake lever (40) in accordance with the present invention comprises a clamping segment (10) and a pressing segment (20).

The clamping segment (10) has a free side, a clamping space (11), an abutting face (12) and a gap (13). The clamping space (11) is defined through the clamping segment (10) to mount around the twist grip throttle (30) of the motorcycle. The abutting face (12) is formed around the clamping space (11) of the clamping segment (10) to abut with an external surface of the twist grip throttle (30). The gap (13) is formed through the free side of the clamping segment (10) and communicates with the clamping space (11) to make the clamping segment (10) expandable for holding the twist grip throttle (30) in the clamping space (11). Preferably, the clamping segment (10) has a first clamping arm (14) and a second clamping arm (15). The clamping space (11) is defined between the gap (13), the clamping arms (14, 15) of the clamping segment (10). Each clamping arm (14, 15) has two abutting faces (12) formed in an inner side of the clamping arm (14, 15) at an angle relative to each other. Preferably, each abutting face (12) of the clamping arms (14, 15) has a non-slip segment.

The pressing segment (20) is connected to the connecting side of the clamping segment (10) opposite to the gap (13), may be formed with the clamping segment (10) to form a one-piece constant speed device and has a first stab (21), a second stab (22) and an expansion joint (23). The first stab (21) is formed with the first clamping arm (14). The second stab (22) is formed with the first stab (21) opposite to the first clamping arm (14) and is formed with the second clamping arm (15). The expansion joint (23) is formed between the stabs (21, 22) and communicates with the clamping space (11) of the clamping segment (10).

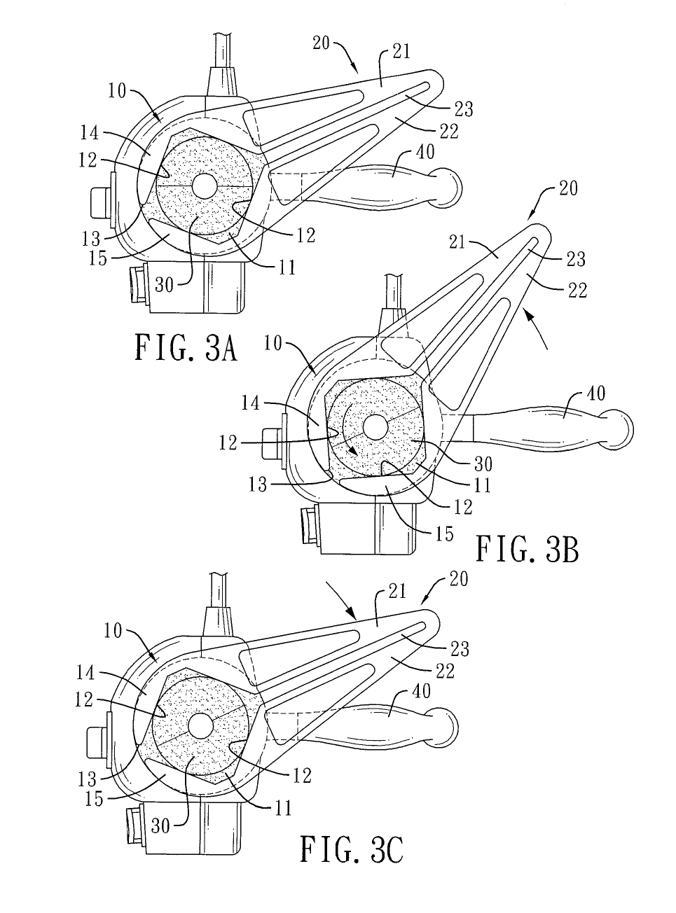

With reference to FIGS. 2 and 3A, when a rider wants to fix the moving speed of the motorcycle, the clamping arms (14, 15) of the clamping segment (10) can be mounted around the twist grip throttle (30) to hold the twist grip throttle (30) in the clamping space (11) via the gap (13). The motorcycle can be moved forward by rotating the twist grip throttle (30) in a counterclockwise direction as shown in FIG. 3B. When the moving speed of the motorcycle is accelerated to a desired speed, the rider can press the pressing segment (20) of the constant speed device downward relative to the twist grip throttle (30) by the rider's finger to abut against the brake lever (40) of the motorcycle as shown in FIG. 3C. After the pressing segment (20) abutting against the brake lever (40), the rider can remove the hand from the twist grip throttle (30) and the twist grip throttle (30) is kept from returning back to the original location due to the abutment between the pressing segment (20) and the brake lever (40). Then, the moving speed of the motorcycle can be fixed at a constant speed by the constant speed device in accordance with the present invention.

The constant speed device for a motorcycle in accordance with the present invention has a simple structure and can provide a constant speed effect to the motorcycle so that the oil consumption of the motorcycle can be efficiently reduced. The constant speed device in accordance with the present invention can be easily assembled onto the twist grip throttle (30) to fix the moving speed of the motorcycle at a constant speed. In addition, if the constant speed device is not in use, the constant speed device can be stored easily. The constant speed device in accordance with the present invention is an extrinsic-supplementary element to the motorcycle and can be mounted on the twist grip throttle (30) conveniently and practicably in use and has a low-cost relative to the conventional electronic constant speed device and this can satisfy the requirements of the users and the market.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A constant speed device for a motorcycle having a twist grip throttle and the constant device comprising
a clamping segment adapted to mount around the twist grip throttle and having
a clamping space defined through the clamping segment to mount around the twist grip throttle of the motorcycle;
an abutting face formed around the clamping space of the clamping segment to abut with the twist grip throttle; and
a gap formed through a side of the clamping segment and communicating with the clamping space to make the clamping segment expandable for holding the twist grip throttle in the clamping space; and
a pressing segment connected to the clamping segment opposite to the gap.

2. The constant speed device as claimed in claim 1, wherein
the clamping segment has a first clamping arm and a second clamping arm; and
the pressing segment has
a first stab formed with the first clamping arm;
a second stab formed with the first stab opposite to the first clamping arm and formed with the second clamping arm; and
an expansion joint formed between the stabs and communicating with the clamping space of the clamping segment.

3. The constant speed device as claimed in claim 2, wherein each clamping arm has two abutting faces formed in an inner side of the clamping arm at an angle relative to each other.

4. The constant speed device as claimed in claim 3, wherein the pressing segment is formed with the clamping segment to form a one-piece constant speed device.

5. The constant speed device as claimed in claim 2, wherein the pressing segment is formed with the clamping segment to form a one-piece constant speed device.

6. The constant speed device as claimed in claim 1, wherein the pressing segment is formed with the clamping segment to form a one-piece constant speed device.
